(19) United States
(12) Patent Application Publication
(10) Pub. No.: US 2008/0253264 A1
(43) Pub. Date: Oct. 16, 2008

(54) OPTICAL PICKUP DEVICE AND OPTICAL DISK APPARATUS

(75) Inventors: Kenji NAGATOMI, Kaidu-Shi (JP); Masaaki Shidochi, Anpachi-Gun (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/101,387

(22) Filed: Apr. 11, 2008

(30) Foreign Application Priority Data
Apr. 12, 2007 (JP) 2007-105351

(51) Int. Cl. G11B 7/135

(52) U.S. Cl. 369/112.16

(57) ABSTRACT

An optical pickup device according to an aspect of the present invention includes a rotary mechanism which rotates a half-wave plate in mechanical conjunction with drive of first and second collimator lenses. The rotary mechanism locates the half-wave plate at a first rotational position when the first collimator lens is located at a control operation position, and the rotary mechanism locates the half-wave plate at a second rotational position when the second collimator lens is located at the control operation position. When the rotational position of the half-wave plate is switched between the first rotational position and the second rotational position, a polarization direction of a laser beam is changed with respect to the polarization beam splitter to switch an optical path of the laser beam.

This application claims priority under 35 U.S.C. Section 119 of Japanese Patent Application No. 2007-105351 filed Apr. 12, 2007, entitled “OPTICAL PICKUP DEVICE AND OPTICAL DISK APPARATUS”.

### BACKGROUND OF THE INVENTION

1. Field of the Invention

The present invention relates to an optical pickup device and an optical disk apparatus into which the optical pickup device is incorporated, particularly to a compatible type optical pickup device sorting a laser beam emitted from a common light source into two objective lenses and an optical disk apparatus into which the optical pickup device is incorporated.

2. Description of the Related Art

Currently, there are two optical disks, i.e., BD (Blu-ray Disc) and HDDVD (High-Definition Digital Versatile Disc), in which a laser beam having a blue wavelength is used. Because BD and HDDVD differ from each other in a thickness of a cover layer, two objective lenses compatible with BD and HDDVD are provided in the optical pickup device compatible with both BD and HDDVD, and the laser beam having the blue wavelength emitted from one semiconductor laser is sorted into the objective lenses by an optical system respectively.

A liquid crystal cell and a polarization beam splitter can be used as a configuration in which the laser beam is sorted into the two objective lenses. In the configuration, a polarization direction of the laser beam is changed into one of P-polarized light and S-polarized light with respect to the polarization beam splitter by the liquid crystal cell. In the case of P-polarized light, the laser beam is transmitted through the polarization beam splitter and guided to a first objective lens. In the case of the S-polarized light, the laser beam is reflected by the polarization beam splitter and guided to the first objective lens.

However, in the configuration, cost of the optical pickup device is increased because the liquid crystal cell is used as a method for sorting the laser beam into the two objective lenses. Unfortunately, laser beam strength is attenuated when the laser beam passes through the liquid crystal cell. Additionally, it is necessary that circuits and configurations for controlling drive of the liquid crystal cell be separately provided to guide the laser beam to which objective lens.

### SUMMARY OF THE INVENTION

In accordance with a first aspect of the present invention, an optical pickup device includes a laser source which emits a laser beam having a predetermined wavelength; first and second objective lenses which cause the laser beam to converge onto a recording medium; a polarization beam splitter which is disposed between the laser beam source and the first and second objective lenses; first and second optical systems which guide the two laser beams split by the polarization beam splitter to the first and second objective lenses respectively; first and second optical elements which are disposed in the first and second optical systems respectively; an actuator which displaces the first and second optical elements in an optical axis direction of the laser beam; a half-wave plate which is disposed between the laser beam source and the polarization beam splitter; and a rotary mechanism which rotates the half-wave plate about an optical axis of the laser beam in mechanical conjunction with drive of the actuator, wherein the rotary mechanism locates the half-wave plate at a first rotational position when the first optical element is located at a control operation position, and the rotary mechanism locates the half-wave plate at a second rotational position when the second optical element is located at the control operation position.

In the optical pickup device according to the first aspect, the half-wave plate is rotated in mechanical conjunction with the actuator which drives the first and second optical elements. The half-wave plate is located at the first rotational position when the first optical element is located at the control operation position, and the half-wave plate is located at the second rotational position when the second optical element is located at the control operation position. Thus, the half-wave plate is rotated to switch the laser beam traveling path between first and second optical systems, thereby switching the target to which the laser beam is incident between the first and second objective lenses. Accordingly, the target to which the laser beam is incident can be switched between the first and second objective lenses without providing an additional configuration for driving the half-wave plate. Additionally, the inexpensive half-wave plate is used as the optical path switching part, so that the cost increase can be suppressed in the optical pickup device.

In accordance with a second aspect of the present invention, an optical pickup device includes a laser source which emits a laser beam having a predetermined wavelength; first and second objective lenses which cause the laser beam to converge onto a recording medium; a polarization beam splitter which is disposed between the laser beam source and the first and second objective lenses; first and second optical systems which guide the two laser beams split by the polarization beam splitter to the first and second objective lenses respectively; an optical element which is disposed in one of the first and second optical systems; an actuator which displaces the optical element in an optical axis direction of the laser beam; a half-wave plate which is disposed between the laser beam source and the polarization beam splitter; and a rotary mechanism which rotates the half-wave plate about an optical axis of the laser beam in mechanical conjunction with drive of the actuator, wherein the rotary mechanism locates the half-wave plate at a first rotational position when the optical element is located at a control operation position, and the rotary mechanism locates the half-wave plate at a second rotational position when the optical element is located at a non-control operation position.

The optical pickup device according to the second aspect differs from the optical pickup device of the first aspect in that the optical element is disposed in one of the first and second optical paths. In the optical pickup device of the second aspect, similarly to the optical pickup device of the first aspect, the target to which the laser beam is incident can be switched between the first and second objective lenses without providing an additional configuration for driving the half-wave plate. Additionally, the inexpensive half-wave plate is used as the optical path switching part, so that the cost increase can be suppressed in the optical pickup device.

In accordance with a third aspect of the present invention, an optical disk apparatus includes an optical pickup device according to the first aspect of the present invention; and a servo circuit which controls the optical pickup device, wherein the servo circuit controlles the actuator to adjust optical characteristics of the laser beams incident to the first and second objective lenses, and drives the actuator to rotate the half-wave plate to guide the laser beam to one of the first and second optical systems.

In accordance with a fourth aspect of the present invention, an optical disk apparatus includes an optical pickup device according to the second aspect of the present invention; and a servo circuit which controls the optical pickup device, wherein the servo circuit controlles the actuator to adjust optical characteristics of the laser beam incident to one of the first and second objective lenses, and drives the actuator to rotate the half-wave plate to guide the laser beam to one of the first and second optical systems.

### BRIEF DESCRIPTION OF THE DRAWINGS

The above and further objects and novel features of the present invention will more fully appear from the following description of embodiments with reference to the accompanying drawings, in which:

FIGS. 1A and 1B show a configuration of an optical pickup device according to an embodiment of the present invention, and FIG. 1C shows a polarization direction of a laser beam;

FIGS. 2A and 2B are views explaining a rotary mechanism of a waveplate holder according to the embodiment;

FIGS. 3A and 3B are views explaining a drive stroke of a lens holder according to the embodiment;

FIG. 4 shows a circuit configuration of an optical disk apparatus according to an embodiment of the present invention;

FIG. 5 shows a configuration of a signal amplifying circuit according to the embodiment;

FIG. 6 is a flowchart showing a reproduction operation of the optical disk apparatus according to the embodiment;

FIGS. 7A and 7B show a modification of the rotary mechanism of the waveplate holder according to the embodiment;

FIGS. 8A and 8B show another modification of the rotary mechanism of the waveplate holder according to the embodiment;

FIGS. 9A to 9D show still another modification of the rotary mechanism of the waveplate holder of the embodiment;

FIGS. 10A to 10D are views explaining an operation of the rotary mechanism of FIGS. 9A to 9D;

FIGS. 11A and 11B show a modification of the optical pickup device according to the embodiment;

FIG. 12 shows another modification of the optical pickup device according to the embodiment;

FIG. 13 shows still another modification of the optical pickup device according to the embodiment; and

FIG. 14 shows still another modification of the optical pickup device according to the embodiment.

However, the drawings are illustrated only by way of example without limiting the scope of the present invention.

### DESCRIPTION OF PREFERRED EMBODIMENTS

Preferred embodiments of the present invention will be described below with reference to the drawings. In the following embodiments, the present invention is applied to an optical pickup device and an optical disk apparatus compatible with Blu-ray Disc (hereinafter, referred to as “BD”) and HDDVD (hereinafter, referred to as “ED”).

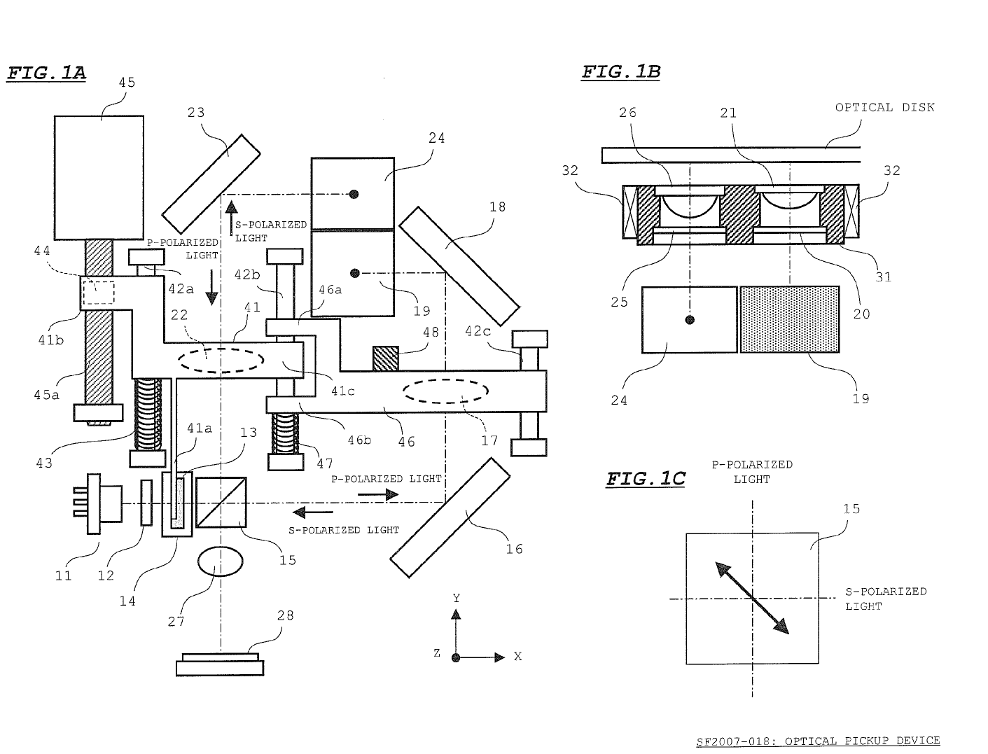

An optical pickup device according to an embodiment of the present invention will be described with reference to FIGS. 1A to 1C. FIG. 1A is a plan view showing an optical system of the optical pickup device, and FIG. 1B is a side view showing a portion subsequent to upwardly reflecting mirrors 19 and 24 of FIG. 1A when viewed from an X-axis direction. In FIG. 1B, an objective lens holder 31 is shown by a sectional view such that an internal structure of the objective lens holder 31 can easily be seen.

Referring to FIGS. 1A and 1B, a semiconductor laser 11 emits a laser beam having a wavelength of about 400 nm. A half-wave plate 12 is provided to adjust a polarization direction of the laser beam with respect to a polarization beam splitter 15. For example, the half-wave plate 12 is provided such that the polarization direction of the laser beam becomes the direction of 45° (arrow direction of FIG. 1C) with respect to a polarization beam splitter 15 for the P-polarized light and S-polarized light.

A waveplate unit 13 holds the half-wave plate 12, and the waveplate unit 13 is held by a holder 14 while being rotatable about a laser beam axis. A rotational position of the waveplate unit 13 is switched between a first rotational position (rotational position during loading BD) and a second rotational position (rotational position during loading HD) by driving the lens holder 41 in a Y-axis direction of FIG. 1A.

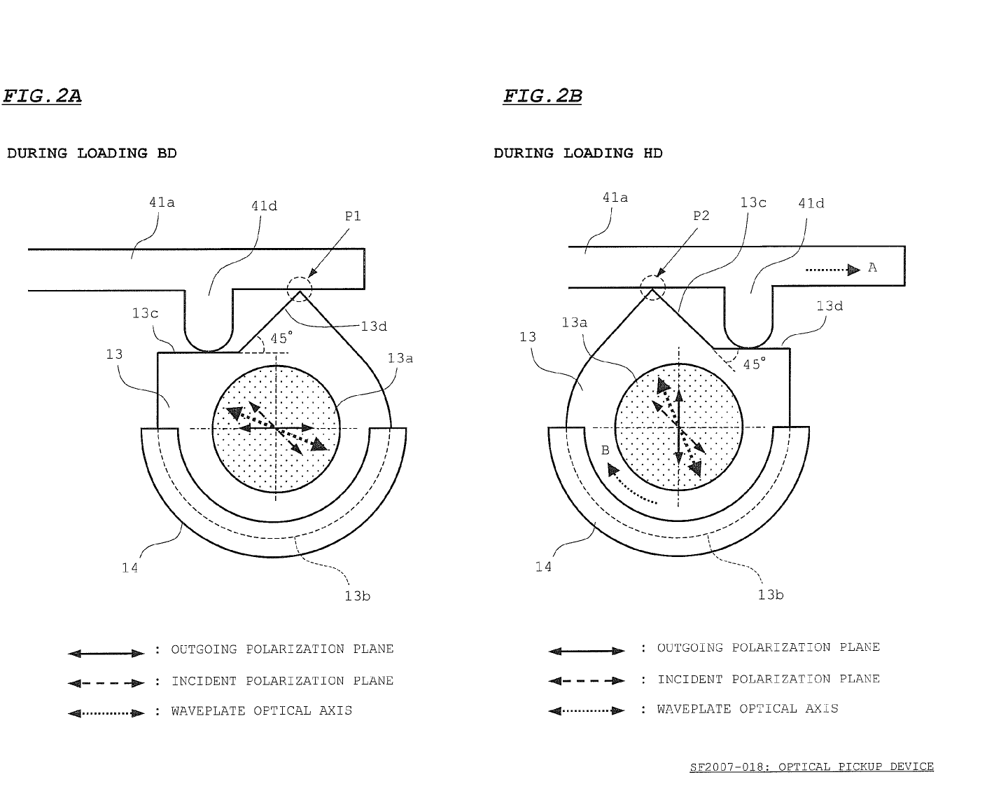

FIGS. 2A and 2B are views explaining a rotating operation of the waveplate unit 13 of the embodiment. As shown in FIGS. 2A and 2B, the waveplate unit 13 has a waveplate area (half-wave plate) 13a in the center thereof, and an arc portion 13b formed in an outer peripheral portion engages an arc groove formed in the holder 14, whereby the waveplate unit 13 is held by the holder 14 while being rotatable about a laser beam axis. Two wall portions 13c and 13d are formed in the waveplate unit 13, and a projection 41d formed in a tongue piece 41a of the lens holder 41 abuts on one of the wall portions 13c and 13d, which allows the waveplate unit 13 to be located at one of the first and second positions.

As shown in FIG. 2A, during loading BD, the projection 41d abuts on the wall portion 13c and an edge of the wall portion 13d abuts on a lower surface of the tongue piece 41a at a position of P1 of FIG. 2A. This enables the waveplate unit 13 to be fixed to the rotational position (first rotational position) shown in FIG. 2A. At this point, an optical axis of the waveplate area 13a is located at the position where the waveplate area 13a is rotated counterclockwise by 22.5 degrees with respect to a polarization direction of the incident laser beam. Accordingly, the polarization direction of the laser beam transmitted through the waveplate area 13a is rotated counterclockwise by 45 degrees in comparison with the laser beam incident to the waveplate area 13a, thereby the laser beam transmitted through the waveplate unit 13 becomes S-polarized light to the polarization beam splitter 15. Due to the rotation of the polarization direction, the laser beam is substantially total-reflected by the polarization beam splitter 15 and almost the whole of laser beam is guided to the collimator lens 22.

During loading HD, the tongue piece 41a is displaced from the state of FIG. 2A toward a direction of an arrow A, and the waveplate unit 13 is rotated clockwise until located at a position of FIG. 2B. At this point, the projection 41d abuts on the wall portion 13d, and the edge of the wall portion 13c abuts on the lower surface of the tongue piece 41a at a position of P2 of FIG. 2B. This enables the waveplate unit 13 to be fixed to the rotational position (second rotational position) shown in FIG. 2B. At this point, the optical axis of the waveplate area 13a is located at the position where the waveplate area 13a is rotated clockwise by 22.5 degrees with respect to the polarization direction of the incident laser beam.

Accordingly, the polarization direction of the laser beam transmitted through the waveplate area 13a is rotated clockwise by 45 degrees in comparison with the laser beam incident to the waveplate area 13a, thereby the laser beam transmitted through the waveplate unit 13 becomes P-polarized light to the polarization beam splitter 15. Due to the rotation of the polarization direction, the laser beam is substantially total-transmitted through the polarization beam splitter 15 and almost the whole of laser beam is guided to the mirror 16.

Referring again to FIGS. 1A and 1B, the polarization beam splitter 15 transmits or reflects the laser beam incident from the side of the semiconductor laser 11 according to the polarization direction of the laser beam. As described above, when the waveplate unit 13 is located at the first rotational position, the laser beam is incident to the polarization beam splitter 15 with the light S-polarized, and the laser beam is substantially total-reflected by the polarization beam splitter 15. On the other hand, when the waveplate unit 13 is located at the second rotational position, the laser beam is incident to the polarization beam splitter 15 with the light P-polarized, and the laser beam is substantially transmitted through the polarization beam splitter 15.

After the laser beam transmitted through the polarization beam splitter 15 is reflected by the mirror 16, the laser beam is converted into parallel light by a collimator lens 17. Then, the laser beam is reflected by a mirror 18, and the laser beam is reflected toward a direction of an HD objective lens 21 by the upwardly reflecting mirror 19.

A quarter-waveplate 20 converts the light reflected from the optical disk into linearly-polarized light (S-polarized light) while converting the laser beam reflected by the upwardly reflecting mirror 19 into circularly-polarized light. The linearly polarized light is orthogonal to the polarization direction in which the laser beam is incident to the optical disk. Therefore, the laser beam reflected from the optical disk is reflected by the polarization beam splitter 15 and introduced to a photodetector 28. The HD objective lens 21 causes the laser beam incident from the side of the quarter-wave plate 20 to converge onto HD.

The laser beam transmitted through the waveplate unit 13 is reflected by the polarization beam splitter 15, and the laser beam is converted into the parallel light by the collimator lens 22. Then, the laser beam is reflected by a mirror 23, and the laser beam is further reflected toward a direction of a BD objective lens 26 by the upwardly reflecting mirror 24.

A quarter-wave plate 25 converts the light reflected from the optical disk into the linearly-polarized light (P-polarized light) while converting the laser beam reflected by the upwardly reflecting mirror 24 into the circularly-polarized light. The linearly polarized light is orthogonal to the polarization direction in which the laser beam is incident to the optical disk. Therefore, the laser beam reflected from the optical disk is transmitted through the polarization beam splitter 15 and introduced to the photodetector 28. The BD objective lens 26 causes the laser beam incident from the side of the quarter-wave plate 25 to converge onto BD.

An anamorphic lens 27 induces astigmatism into the laser beam reflected from the optical disk. The photodetector 28 includes a quadratic sensor in a light acceptance surface thereof, and the photodetector 28 is disposed such that an optical axis of the laser beam reflected from the optical disk pierces through an intersection point of two parting lines of the quadratic sensor. A focus error signal, a tracking error signal, and a reproduction signal are generated based on signals from the quadratic sensor.

As shown in FIG. 1B, the two quarter-wave plates 20 and 25, the HD objective lens 21, and the BD objective lens 26 are attached to the common objective lens holder 31. The objective lens holder 31 is driven in a focus direction and in a tracking direction by a well-known objective lens actuator including a magnetic circuit and a coil. Usually the coil is disposed in the objective lens holder 31. In the objective lens actuator of FIG. 1B, only a coil 32 is shown and the magnetic circuit is omitted.

In the two collimator lenses, the BD collimator lens 22 is attached to a lens holder 41. The lens holder 41 is supported by guide shafts 42a and 42b provided in parallel on the support base, and the lens holder 41 can be moved in an optical axis direction of the collimator lens 22. The tongue piece 41a having a predetermined width in a Z-axis direction of FIG. 1A is formed in the lens holder 41, and the projection 41d is attached to the lower surfaces of the tongue piece 41a as described above.

A projection 41b is formed in the lens holder 41, and a rack gear 44 is provided in a lower surface of the projection 41b. On the other hand, a motor 45 is placed on the support base, and a worm gear 45a is formed in a rotary shaft of the motor 45. The motor 45 is formed by, for example, a stepping motor. The rack gear 44 provided in the lower surface of the projection 41b of the lens holder 41 is brought into press-contact with the rotary shaft of the motor 45 so as to engage the worm gear 45a. Therefore, when the motor 45 is driven, a driving force of the motor 45 is transmitted to the lens holder 41 through the worm gear 45a and rack gear 44. This enables the lens holder 41 to be moved in the optical axis direction of the collimator lens 22.

A guide shaft 42a is inserted into a spring 43, and the lens holder 41 is biased toward the direction of the motor 45 by the spring 43. The biasing force eliminates mechanical play of the motor shaft in a longitudinal direction.

The HD collimator lens 17 is attached to a lens holder 46. The lens holder 46 is supported by guide shafts 42b and 42c provided in parallel on the support base, and the lens holder 46 can be moved in the optical axis direction of the collimator lens 17. Accordingly, the guide shaft 42b supports both the lens holder 41 and the lens holder 46. Two supported portions (hereinafter referred to as “second supported portion 46a and 46b”) on the side of the lens holder 46 are provided so as to sandwich a supported portion (hereinafter referred to as “first supported portion 41c”) on the side of the lens holder 41 in the Y-axis direction of FIG. 1A. Predetermined gaps exist between the first supported portion 41c and the second supported portions 46a and 46b.

The guide shaft 42b is inserted into a spring 47, and the biasing force of the spring 47 brings the lens holder 46 into press-contact with a stopper 48 on the support base.

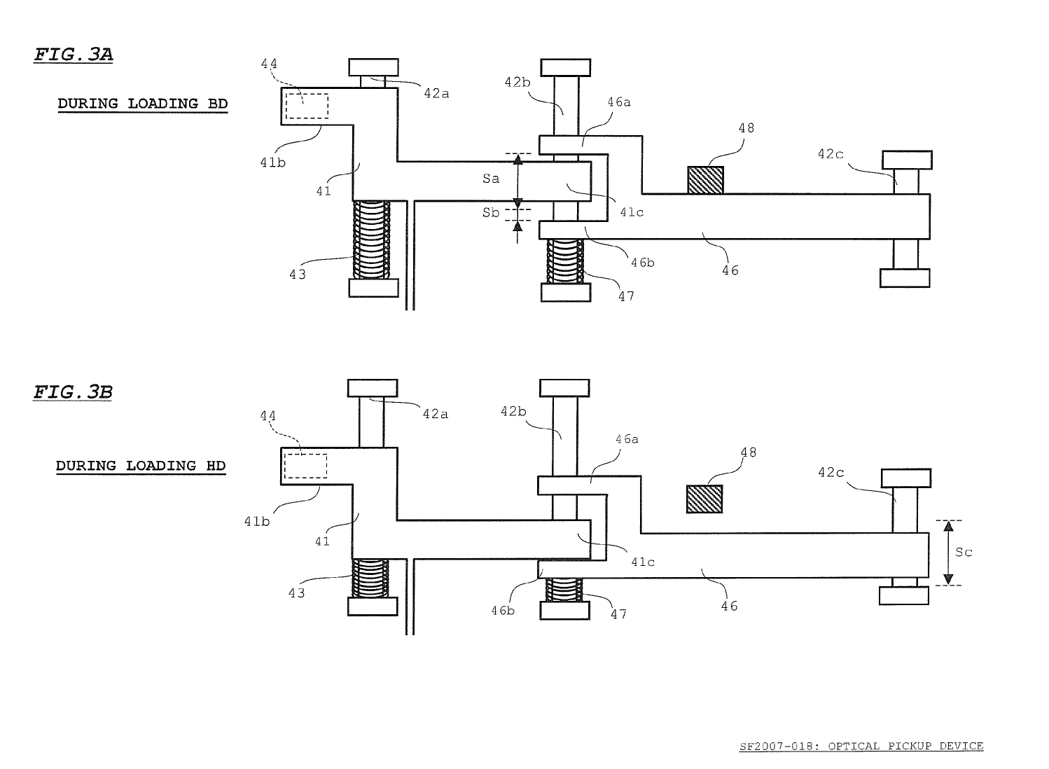

FIGS. 3A and 3B are views explaining drive strokes of the lens holders 41 and 46.

Referring to FIG. 3A, the lens holder 41 is driven in a range of a stroke Sa when an aberration correction operation is performed during loading BD. In this case, the first supported portion 41c does not abut on the second supported portions 46a and 46b, but the first supported portion 41c is moved between the second supported portions 46a and 46b. In addition to the stroke Sa, a stroke Sb remains between the first supported portion 41c and the second supported portions 46a and 46b.

When HD is loaded, the lens holder 41 is moved from the state of FIG. 1A across the stroke Sb to the lower portion of FIG. 1A. At this point, the first supported portion 41c abut on the second supported portion 46b in the middle of the movement, and the lens holder 41 is further moved to the lower portion of FIG. 1A, whereby the lens holder 46 is moved to the position of FIG. 1B against the biasing force of the spring 47. Therefore, the lens holder 46 is located at a position where aberration correction is performed by the collimator lens 17. The lens holder 46 is displaced in a range of a stroke Sc during the aberration correction operation.

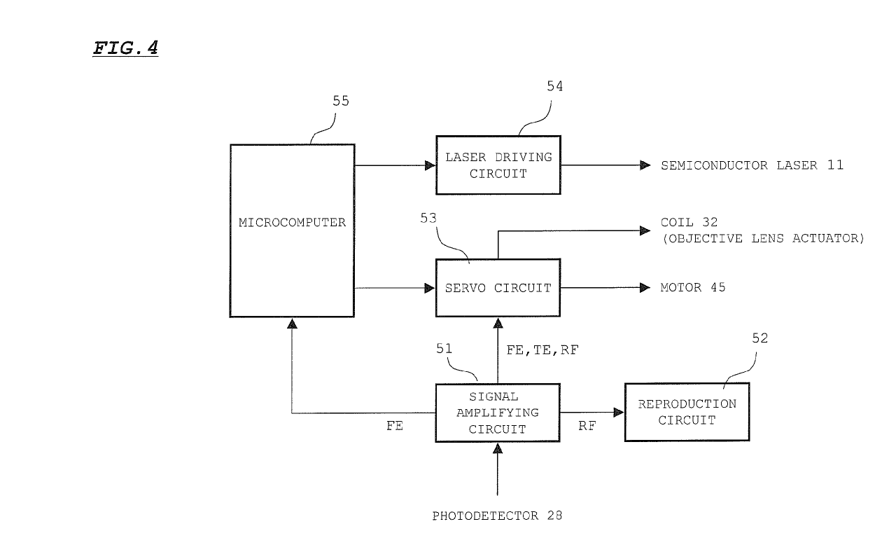

FIG. 4 shows a circuit configuration of an optical disk apparatus into which the optical pickup device is incorporated. FIG. 4 shows only portions related to the optical pickup device in the circuit configuration of the optical disk apparatus.

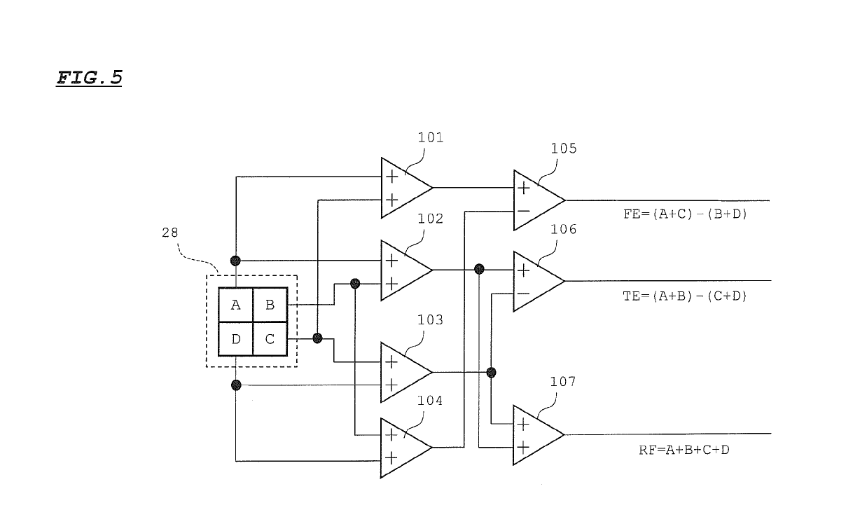

A signal amplifying circuit 51 generates a focus error signal (FE), a tracking error signal (TE), and a reproduction signal (RF) based on the signals inputted from the photodetector 28. FIG. 5 shows a configuration of the signal amplifying circuit 51. As shown in FIG. 5, the signal amplifying circuit 51 includes five adding circuits 101 to 104 and 107 and two subtracting circuits 105 and 106. As described above, the quadratic sensor is disposed in the photodetector 28. Assuming that A to D are signals from the sensors A to D shown in FIG. 5, the focus error signal (FE) , the tracking error signal (TE), and the reproduction signal (RF) are generated by computations of FE=(A+C)−(B+D), TE=(A+B)−(C+D), and RF=A+B+C+D, respectively.

Referring again to FIG. 4, a reproduction circuit 52 reproduces data by processing the reproduction signal (RF) inputted from the signal amplifying circuit 51.

A servo circuit 53 generates a focus servo signal and a tracking servo signal based on the focus error signal (FE) and tracking error signal (TE) inputted from the signal amplifying circuit 51, and the servo circuit 53 supplies the focus servo signal and the tracking servo signal to the coil 32 (objective lens actuator) in the optical pickup device. In reproducing BD and HD, the servo circuit 53 monitors the reproduction signal (RF) inputted from the signal amplifying circuit 51, the servo circuit 53 generates a servo signal (aberration servo signal) to drive and control the collimator lenses 22 and 17 such that the reproduction signal (RF) becomes the best, and the servo circuit 53 supplies the servo signal to the motor 45 in the optical pickup device.

Further, the servo circuit 53 supplies a signal to the motor 45 to locate the lens holder 41 at one of a first position (initial position of collimator lens 22) and a second position (initial position of collimator lens 17) according to a control signal inputted from a microcomputer 55. When the lens holder 41 is located at the first position, the waveplate unit 13 is located at the first rotational position (see FIG. 2A). When the lens holder 41 is located at the second position, the waveplate unit 13 is located at the second rotational position (see FIG. 2B) . Additionally, the servo circuit 53 supplies a focus pull-in signal to the coil 32 (objective lens actuator) in the optical pickup device.

A laser driving circuit 54 drives the semiconductor laser 11 in the optical pickup device according to the control signal inputted from the microcomputer 55. The microcomputer 55 controls each unit according to a program stored in a built-in memory.

Next, an operation of the optical pickup device will be described below with reference to FIGS. 1A and 1B.

When BD is loaded in the optical disk apparatus, the lens holder 41 is located at the first position, and the waveplate unit 13 is located at the first rotational position (see FIG. 2A). At this point, the collimator lens 22 is located at an initial position (predetermined position for forming the laser beam in the parallel light) in the stroke Sa of FIG. 3A. When the waveplate unit 13 is located at the first rotational position, the laser beam is transmitted through the waveplate unit 13 to become the S-polarized light with respect to the polarization beam splitter 15. Therefore, the laser beam is substantially total-reflected by the polarization beam splitter 15.

After the laser beam reflected by the polarization beam splitter 15 is formed in the parallel light by the collimator lens 22, the laser beam is reflected by the mirror 23, and the laser beam is further reflected toward the BD objective lens 26 by the upwardly reflecting mirror 24. Then, the laser beam is converted into the circularly-polarized light by the quarter-wave plate 25, and the laser beam is caused to converge onto BD by the objective lens 26.

The laser beam reflected from BD is transmitted through the quarter-wave plate 25 again, thereby converting the laser beam into the linearly-polarized light orthogonal to the polarization direction in which the laser beam is incident to BD. Then, the laser beam reversely travels in the optical path, and the laser beam is incident to the polarization beam splitter 15. At this point, the laser beam is substantially total-transmitted through the polarization beam splitter 15 because the polarization direction of the laser beam becomes the P-polarized light with respect to the polarization beam splitter 15. Then, the anamorphic lens 27 induces the astigmatism into the laser beam, and the laser beam converges onto the light acceptance surface (quadratic sensor) of the photodetector 28.

In performing the reproduction operation to BD, the aberration servo signal is supplied to the motor 45, and the collimator lens 22 is finely moved in the optical axis direction in the aberration correction stroke range (stroke Sa of FIG. 3A), thereby suppressing the aberration generated in the laser beam on BD.

When HD is loaded in the optical disk apparatus, the lens holder 41 is located at the second position, and the waveplate unit 13 is located at the second rotational position (see FIG. 2B). At this point, the collimator lens 17 is located at an initial position (predetermined position for forming the laser beam in the parallel light) in the stroke Sc of FIG. 3B. Therefore, the laser beam becomes the P-polarized light with respect to the polarization beam splitter 15, and the laser beam is substantially total-transmitted through the polarization beam splitter 15.

The laser beam transmitted through the polarization beam splitter 15 is reflected by the mirror 16 and formed in the parallel light by the collimator lens 17. Then, the laser beam is reflected by the mirror 18, and the laser beam is further reflected toward the HD objective lens 21 by the upwardly reflecting mirror 19. Then, the laser beam is converted into the circularly-polarized light by the quarter-wave plate 20, and the laser beam is caused to converge onto HD by the objective lens 21.

The laser beam reflected from HD is transmitted through the quarter-wave plate 20 again, thereby converting the laser beam into the linearly-polarized light orthogonal to the polarization direction in which the laser beam is incident to HD. Then, the laser beam reversely travels in the optical path, and the laser beam is incident to the polarization beam splitter 15. At this point, the laser beam is substantially total-reflected by the polarization beam splitter 15 because the polarization direction of the laser beam becomes the S-polarized light with respect to the polarization beam splitter 15. Then, the anamorphic lens 27 induces the astigmatism into the laser beam, and the laser beam converges onto the light acceptance surface (quadratic sensor) of the photodetector 28.

In performing the reproduction operation to HD, the aberration servo signal is supplied to the motor 45, the collimator lens 17 is finely moved in the optical axis direction in the aberration correction stroke range (stroke Sc of FIG. 3B), thereby suppressing the aberration generated in the laser beam on HD.

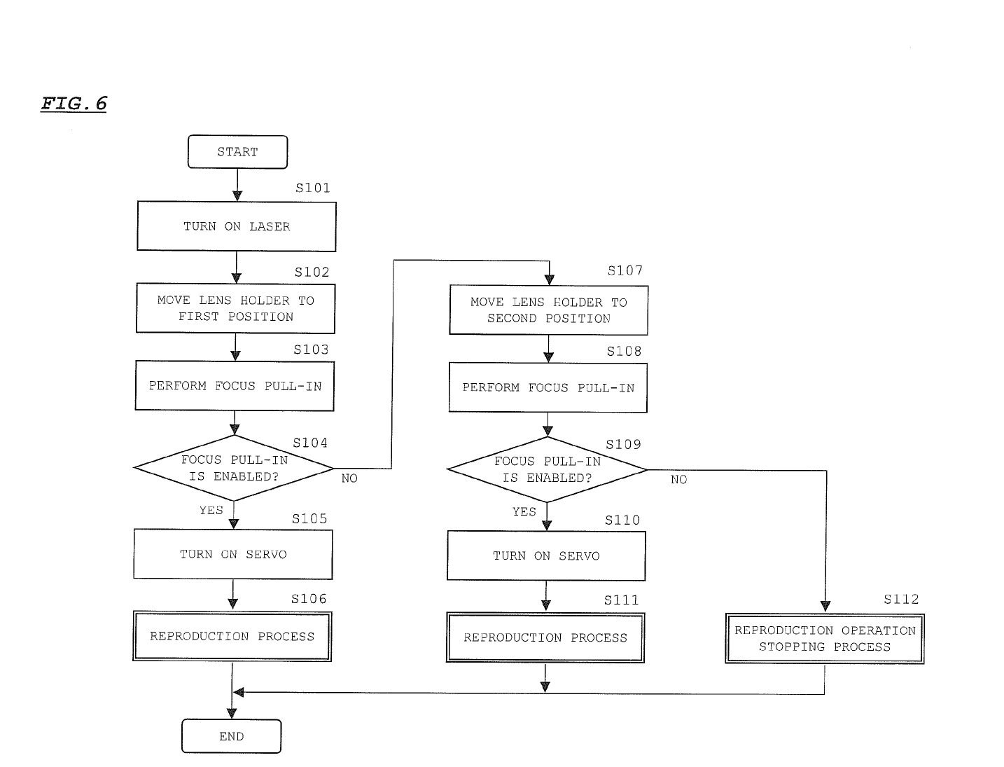

A reproduction operation of the optical disk apparatus will be described below with reference to FIG. 6.

When the reproduction operation is started, the semiconductor laser 11 is turned on (S101), and the lens holder 41 is moved to the first position (S102). Therefore, the optical disk to be reproduced is irradiated with the laser beam through the BD objective lens 26. At this point, the collimator lens 22 is located at the initial position in the stroke Sa of FIG. 3A.

Then, the objective lens holder 31 is moved in the focus direction to try the focus pull-in of the laser beam to the optical disk to be reproduced (S103) . When BD is the optical disk to be reproduced, an S-shape curve having sufficient waveform amplitude appears on the focus error signal to enables the focus pull-in (YES in S104). In this case, the microcomputer 55 determines that BD is the optical disk to be reproduced, and the microcomputer 55 causes the servo circuit 53 to perform a BD servo process (S105). Therefore, the servo (focus servo and tracking servo) is applied to the BD objective lens 26, and the aberration servo is applied to the collimator lens 22. Then, the reproduction process is performed to the optical disk (S106).

On the other hand, when BD is not the optical disk to be reproduced, the S-shape curve having the sufficient waveform amplitude does not appear on the focus error signal due to the difference in cover layer and the like, and the focus pull-in is not enabled (NO in S104). In this case, the microcomputer 55 determines that BD is not the optical disk to be reproduced, and the microcomputer 55 moves the lens holder 41 to the second position (S107). Therefore, the lens holder 46 is displaced against the biasing force of the spring 47, and the collimator lens 17 is located at the initial position of the stroke Sc of FIG. 3B. At the same time, the waveplate holder 13 is located at the second rotational position, and the polarization direction of the laser beam becomes the P-polarized light when the laser beam is incident to the polarization beam splitter 15. Therefore, the optical disk to be reproduced is irradiated with the laser beam through the HD objective lens 21.

Then, the microcomputer 55 re-tries the focus pull-in of the laser beam to the optical disk to be reproduced (SL08). When HD is the optical disk to be reproduced, the S-shape curve having the sufficient waveform amplitude appears on the focus error signal to enables the focus pull-in (YES in S109). In this case, the microcomputer 55 determines that HD is the optical disk to be reproduced, and the microcomputer 55 causes the servo circuit 53 to perform a HD servo process (S110). Therefore, the servo (focus servo and tracking servo) is applied to the HD objective lens 21, and the aberration servo is applied to the collimator lens 17. Then, the reproduction process is performed to the optical disk (S111).

When the S-shape curve having the sufficient waveform amplitude does not appear on the focus error signal in the focus pull-in in Step S108, the microcomputer 55 determines that neither BD nor HD is the optical disk to be reproduced, and the microcomputer 55 stops the reproduction operation to the optical disk (S112). In this case, a user is informed of a disk error by ejecting the optical disk or by displaying error display on a monitor.

Thus, according to the embodiment, the waveplate unit 13 is located at one of the first rotational position and the second rotational position using the actuator driving the collimator lenses 17 and 22, and the target to which the laser beam is incident is switched between the BD objective lens 26 and the HD objective lens 21. Therefore, the need for the additional configuration for driving the waveplate unit 13 is eliminated to achieve the simple configuration of the optical pickup device. Because the inexpensive half-wave plate is used as the optical path switching part, the cost increase can be suppressed in the optical pickup device. Because the optical paths are switched only by controlling the drive of the motor 45, the circuit configuration and the control process become simplified on the optical disk apparatus side.

Additionally, according to the embodiment, the gaps are provided between the first supported portion 41c and the second supported portions 46a and 46b as shown in FIGS. 3A and 3B, which allows the drive stroke of the lens holder 46 to be suppressed to shorten the optical path between the mirrors 16 and 18. Therefore, even if the large optical path is not ensured between the mirrors 16 and 18 due to the layout, the collimator lens 17 can smoothly be driven by the common motor 45.

Accordingly, the embodiment provides the optical pickup device which can smoothly sort the laser beam into the two objective lenses 21 and 26 with the simple configuration and the optical disk apparatus into which the optical pickup device is incorporated.

The present invention is not limited to the embodiment, but various modifications can be made.

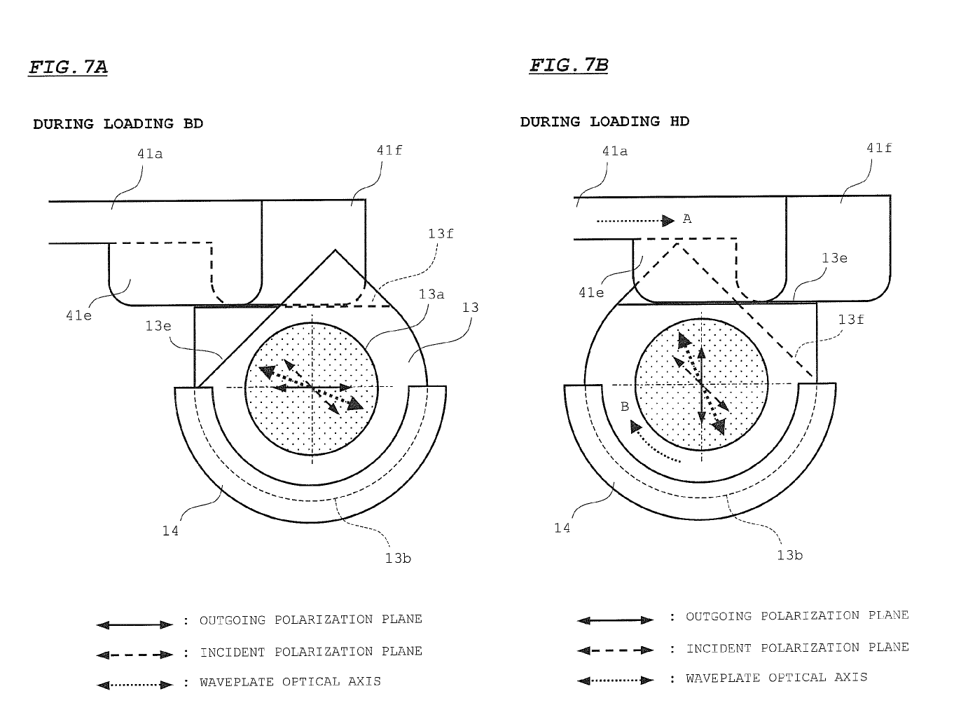

FIGS. 7A and 7B show a modification of the rotary mechanism of the waveplate unit 13. In the waveplate unit 13, two wall portions 13e and 13f are formed while shifted in the laser beam axis direction. An upper surface of the wall portion 13e is inclined counterclockwise by 45 degrees with respect to an upper surface of the wall portion 13f. In the tongue piece 41a, two projection pieces 41e and 41f are formed in a longitudinal direction of the tongue piece 41a at positions facing the two wall portions 13e and 13f.

As shown in FIG. 7A, during loading BD, the lower surface of the projection piece 41f is brought into surface contact with the upper surface of the wall portion 13f, which allows the waveplate unit 13 to be fixed to the rotational position (first rotational position) shown in FIG. 7A. During loading HD, the tongue piece 41a is displaced from the state of FIG. 7A toward the direction of the arrow A, and a front end of the projection piece 41e abuts on the upper surface of the wall portion 13e to press the wall portion 13e toward the direction of the arrow A. At this point, a rear end of the projection piece 41f crosses the rotating center of the waveplate unit 13 in the direction of the arrow A, which allows the waveplate unit 13 to be rotated clockwise. Therefore, the projection piece 41e presses the wall portion 13e to rotate the wall portion 13e clockwise, the lower surface of the projection piece 41e is brought into surface contact with the upper surface of the wall portion 13e, and the waveplate unit 13 is fixed to the rotational position (second rotational position) shown in FIG. 7B.

In the modification of FIG. 7, the lower surfaces of the projection pieces 41e and 41f are brought into surface contact with the upper surfaces of the wall portion 13e and 13f to locate the waveplate unit 13 at the first and second rotational positions, so that the position shift of the waveplate unit 13 can smoothly be suppressed with respect to the first and second rotational positions.

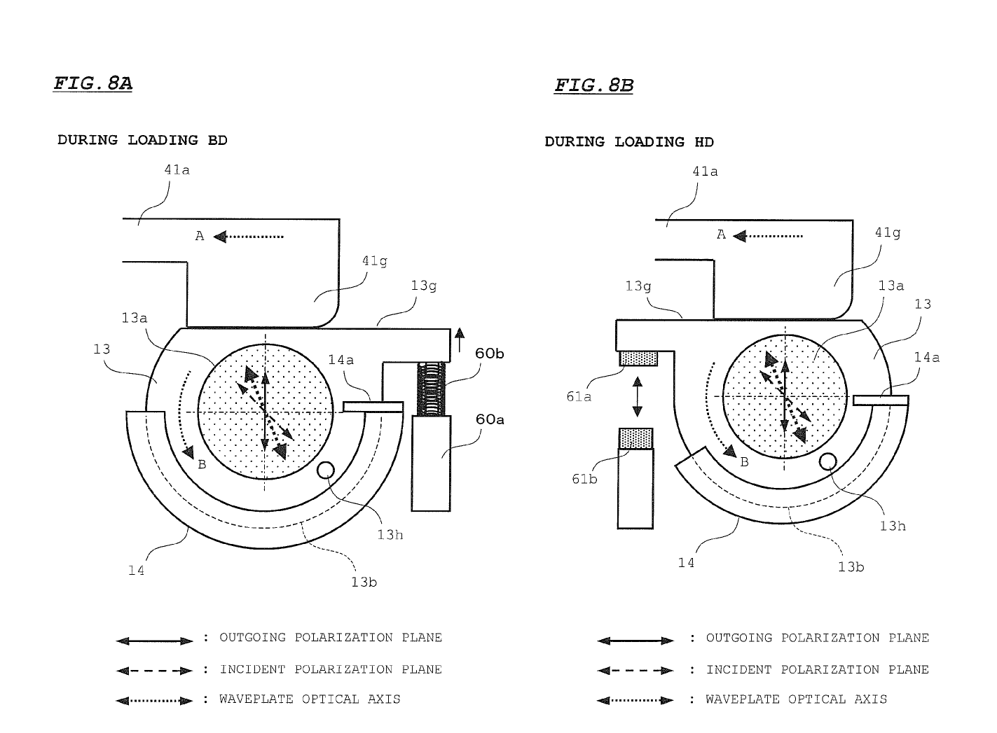

FIGS. 8A and 8B show another modification of the rotary mechanism of the waveplate unit 13.

In the modification of FIG. 8, a projection piece 41g is formed in an end portion of the tongue piece 41a, and the lower surface of the projection piece 41g is brought into surface contact with an upper surface 13g of the waveplate unit 13 during loading HD, thereby fixing the waveplate unit 13 to the second rotational position.

In the modification of FIG. 8A, a spring 60b is provided between the waveplate unit 13 and a spring shoe 60a, and an elastic force of the spring 60b biases the waveplate unit 13 counterclockwise. In the modification of FIG. 8B, the waveplate unit 13 is biased counterclockwise by a magnetic force between a magnetic plate 61a provided in the waveplate unit 13 and a magnet 61b provided on a base side.

During loading BD, the tongue piece 41a is displaced from the states of FIGS. 8A and 8B toward the direction of the arrow A. When the rear end of the projection piece 41g crosses the rotating center of the waveplate unit 13 by the displacement, the waveplate unit 13 is rotated counterclockwise by the elastic force of the spring 60b or the magnetic force between the magnetic plate 61a and the magnet 61b. Then, a stopper 13h formed in the waveplate unit 13 abuts on a projection piece 14a formed in the holder 14 to regulate the rotation of the waveplate unit 13, thereby fixing the waveplate unit 13 to the second rotational position.

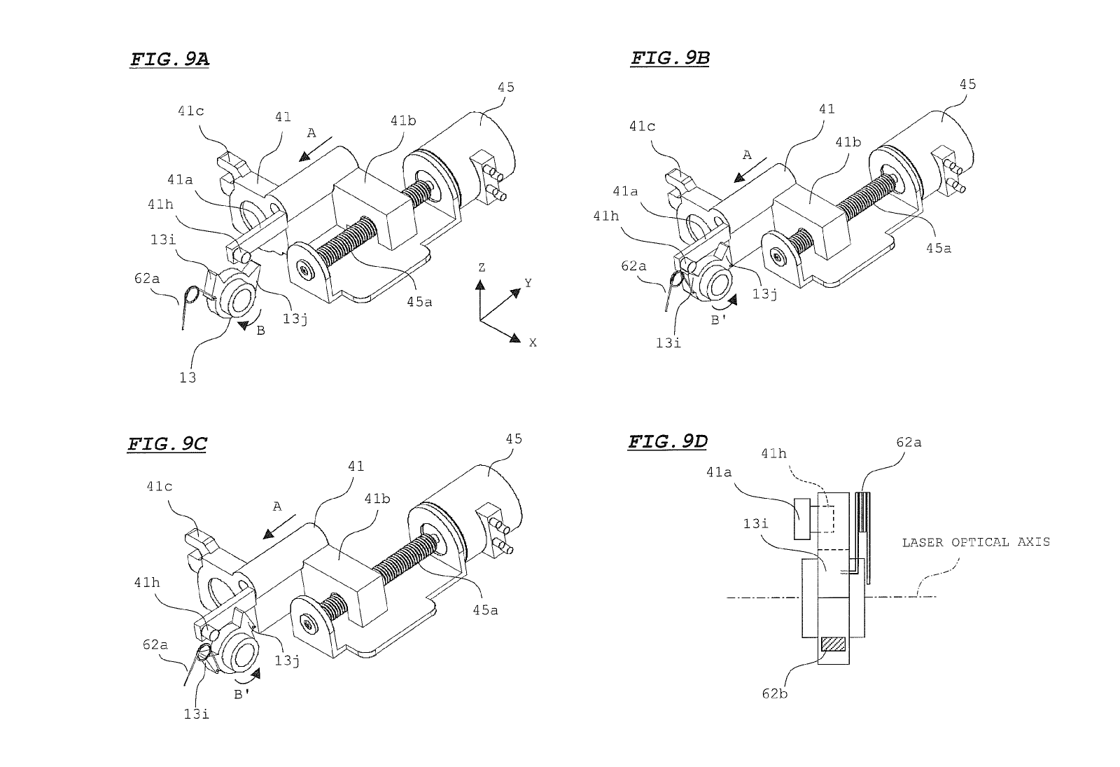

FIGS. 9A to 9D show still another modification of the rotary mechanism of the waveplate unit 13. In the modification of FIG. 9, the waveplate unit 13 is located at the first rotational position and the second rotational position using a torsion spring.

FIGS. 9A to 9C are partial perspective view showing a rotation transition of the waveplate unit 13, and FIG. 9D is a partial side view showing the waveplate unit 13 when viewed from the Y-axis direction of FIG. 9A. As shown in FIG. 9, in the waveplate unit 13, two projections 13i and 13j are formed in the outer peripheral portion, and one end of a torsion spring 62a is attached to a position where the projection 13i is formed.

In FIG. 9A, the torsion spring 62a biases the waveplate unit 13 toward a direction of an arrow B. When the lens holder 41 is displaced from the state of FIG. 9A toward the direction of the arrow A, a pin 41h formed in the end portion of the tongue piece 41a presses the projection 13i, and the waveplate unit 13 is rotated in a direction of an arrow B′ against the bias of the torsion spring 62a (see FIG. 9B) . Due to the rotation, when the rotational position of the waveplate unit 13 crosses a neutral position of the torsion spring 62a, the biasing direction of the torsion spring 62a is reversed with respect to the waveplate unit 13, thereby biasing the waveplate unit 13 toward the direction of the arrow B′. Therefore, the waveplate unit 13 is rotated in the direction of the arrow B′ while not pressed by the pin 41h until the rotation of the projection 13i is regulated by the stopper 62b (see FIG. 9C).

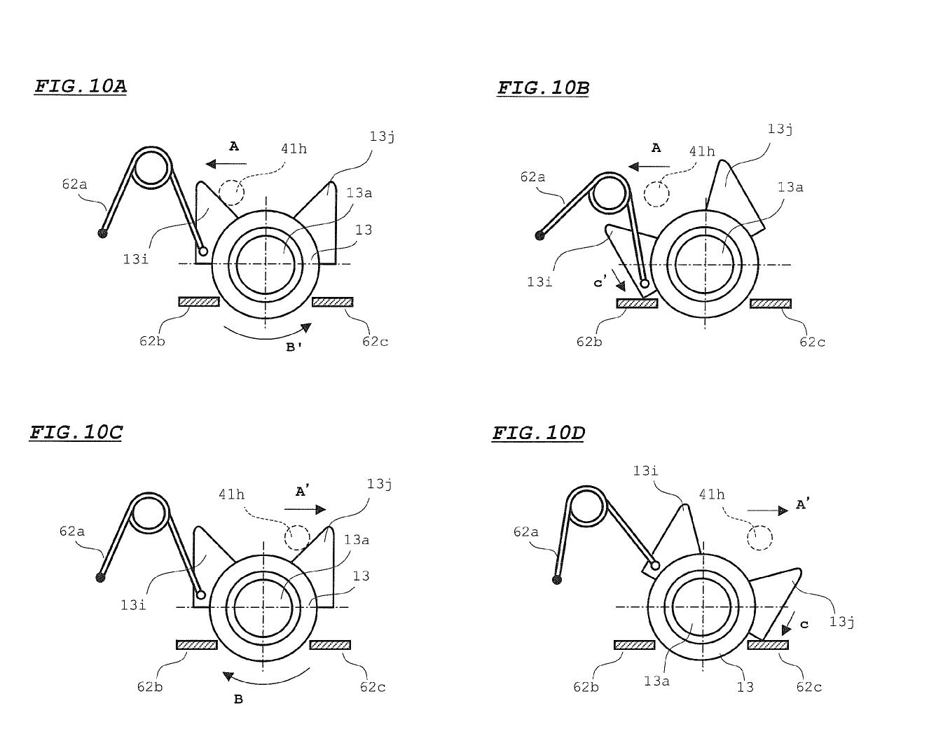

FIGS. 10A to 10D are views explaining an operation of the waveplate unit 13 in the modification of FIG. 9. It is assumed that the rotational positions of the waveplate unit 13 in FIGS. 10B and 10D correspond to the first rotational position and the second rotational position.

When the lens holder 41 is displaced from the second position (HD reproduction position) to the first position (BD reproduction position), the pin 41h formed in the tongue piece 41a abuts on the projection 13i in the middle of the displacement, and the waveplate unit 13 is rotated from the second rotational position toward the first rotational position against the bias of the torsion spring 62a. FIG. 10A shows the state. When the rotational position of the waveplate unit 13 crosses the neutral position of the torsion spring 62a, the biasing direction of the torsion spring 62a is reversed toward a direction of an arrow C′ with respect to the waveplate unit 13, thereby biasing the waveplate unit 13 toward the direction of the arrow B′. Therefore, the waveplate unit 13 is rotated in the direction of the arrow B′ while not pressed by the pin 41h until the rotation of the projection 13i is regulated by the stopper 62b (see FIG. 10B), whereby the waveplate unit 13 is fixed to the first rotational position. Then, the lens holder 41 is further displaced to the first position (initial position of collimator lens 22) in the direction of the arrow A.

When the lens holder 41 is displaced from the first position toward the second position, the pin 41h formed in the tongue piece 41a abuts on the projection 13j, and the waveplate unit 13 is rotated from the first rotational position toward the second rotational position against the bias of the torsion spring 62a. FIG. 10C shows the state. When the rotational position of the waveplate unit 13 crosses the neutral position of the torsion spring 62a, the biasing direction of the torsion spring 62a is reversed toward the direction of the arrow C with respect to the waveplate unit 13, thereby biasing the waveplate unit 13 toward the direction of the arrow B. Therefore, the waveplate unit 13 is rotated in the direction of the arrow B while not pressed by the pin 41h until the rotation of the projection 13j is regulated by the stopper 62b, whereby the waveplate unit 13 is fixed to the second rotational position (see FIG. 10D) . Then, the lens holder 41 is further displaced to the second position (initial position of collimator lens 17) in the direction of the arrow A′.

In the modification of FIG. 9, the projections 13i and 13j is pressed against the stoppers 62b and 62c by the torsion spring 62a, whereby the waveplate unit 13 is located at the first and second rotational position. Therefore, the position shift of the waveplate unit 13 can effectively be suppressed with respect to the first and second rotational positions.

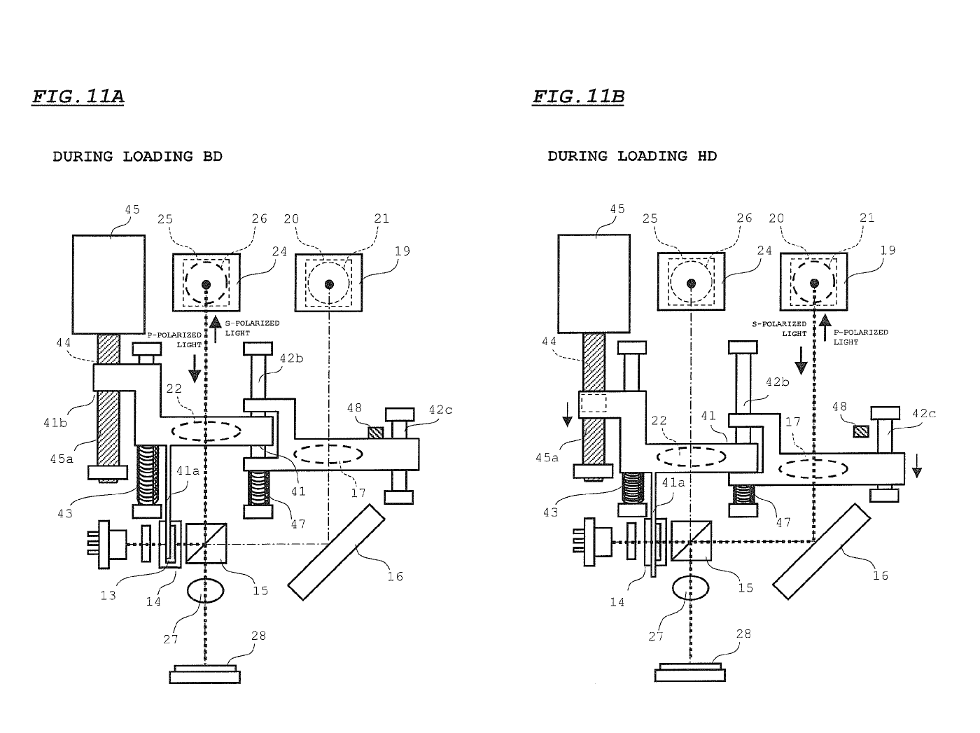

Additionally, the HD objective lens 21 and the BD objective lens 26 may be disposed as shown in FIGS. 11A and 11B. In this case, the mirrors 18 and 23 of FIG. 1 can be omitted to achieve the simple configuration and the reduced number of components.

In the embodiment, the tracking error signal (TE) is generated by the one-beam push pull. In the case where the optical disk apparatus can record the data in the optical disk, the tracking error signal can also be generated by a DPP (Deferential Push Pull) method in which the three beams are used. In this case, the half-wave plate 12 of FIG. 1A may be replaced by a half-wave plate in which a three-beam diffraction grating is formed in the surface thereof. The half-wave plate has both a function of adjusting the polarization direction of the laser beam in the direction shown in FIG. 1C and a function of dividing the laser beam from the semiconductor laser 11 into three beams by diffraction.

Because BD differs from HD in a track pitch, an in-line pattern is applied to a pattern of the three-beam diffraction grating. Therefore, the light reflected from the optical disk can be accepted by the common light acceptance surface regardless of whether the optical disk to be recorded and reproduced is BD or HD. Because the in-line DPP method is well-known technique, the description is omitted. In this case, it is necessary to appropriately change the sensor pattern of the photodetector 28 and the signal amplifying circuit which computes the output from each sensor.

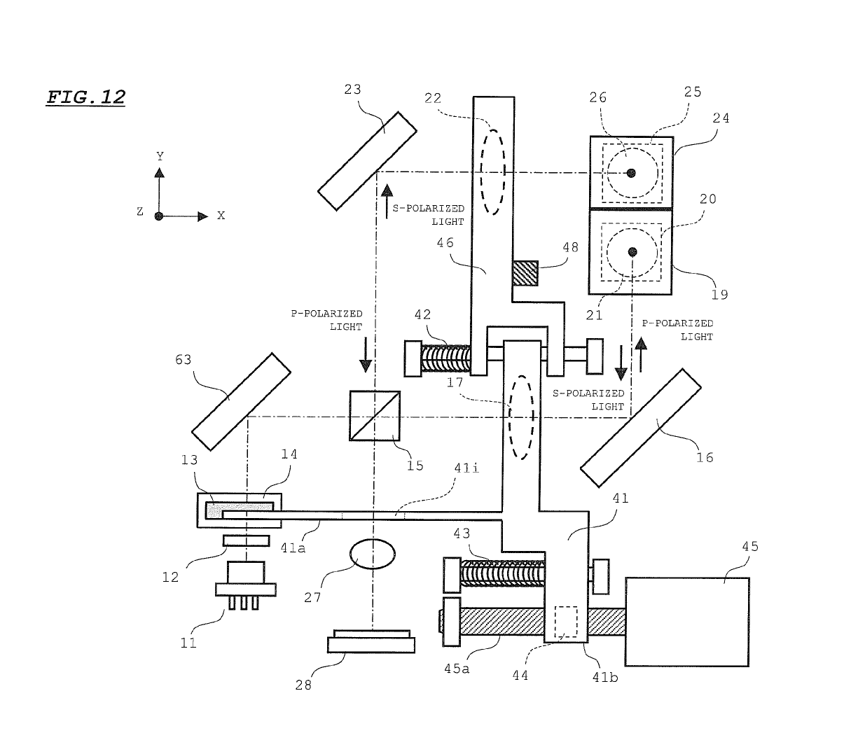

In the embodiment, the lens holder 41 is moved in the same direction as the optical axis of the laser beam reflected by the polarization beam splitter 15. Alternatively, as shown in FIG. 12, the lens holder 41 may be moved in the same direction as the optical axis of the laser beam transmitted through the polarization beam splitter 15. In this case, the collimator lenses 17 and 22 are displaced in the X-axis direction. An opening 41i is formed in the tongue piece 41a of the lens holder 41 so as not to obstruct the laser beam traveling from the polarization beam splitter 15 toward the anamorphic lens 27. The arrangement of the semiconductor laser 11 and the half-wave plate 12 is changed as shown in FIG. 12, and a mirror 63 is added to guide the laser beam transmitted through the half-wave plate 13 to the polarization beam splitter 15.

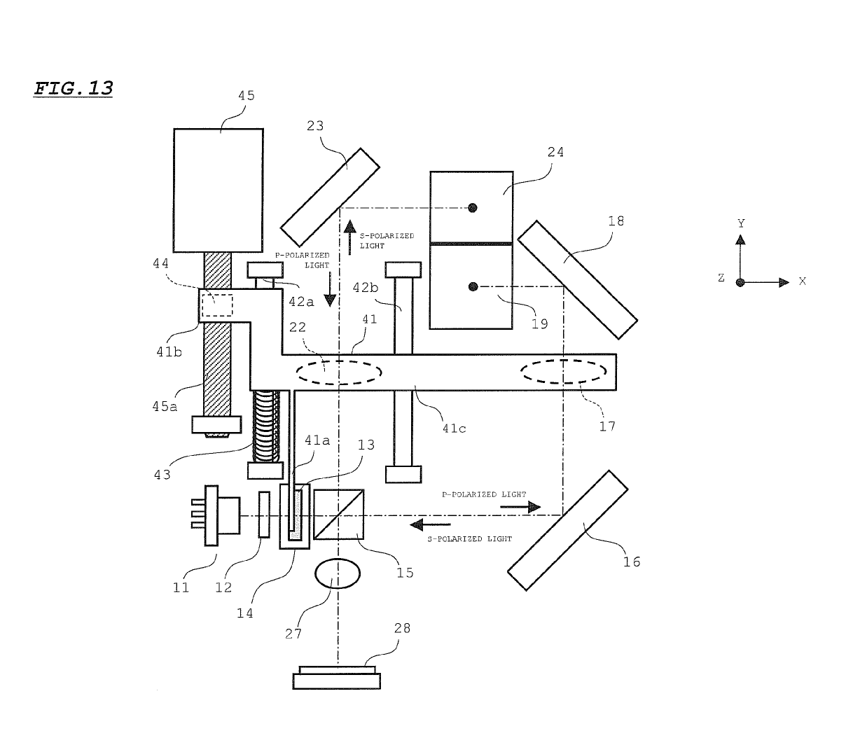

In the embodiment, the collimator lenses 22 and 17 are attached to the lens holders 41 and 46, and the gaps are provided between the first supported portion 41c and the second supported portions 46a and 46b to displace the drive strokes of the collimator lenses 22 and 17. Alternatively, as shown in FIG. 13, the two collimator lenses 22 and 17 may be attached to the one lens holder 41 to integrally move the collimator lenses 22 and 17. In this case, similarly to the embodiment, the optical system and the rotary mechanism of the waveplate holder 13 are configured such that the lens holder 41 is moved between the first position (initial position of collimator lens 22) and the second position (initial position of collimator lens 17) to locate the waveplate holder 13 at the first rotational position and the second rotational position.

In the embodiment, both the collimator lenses 17 and 22 are displaced to perform the aberration correction. Alternatively, one of the collimator lenses 17 and 22 may be displaced to perform the aberration correction.

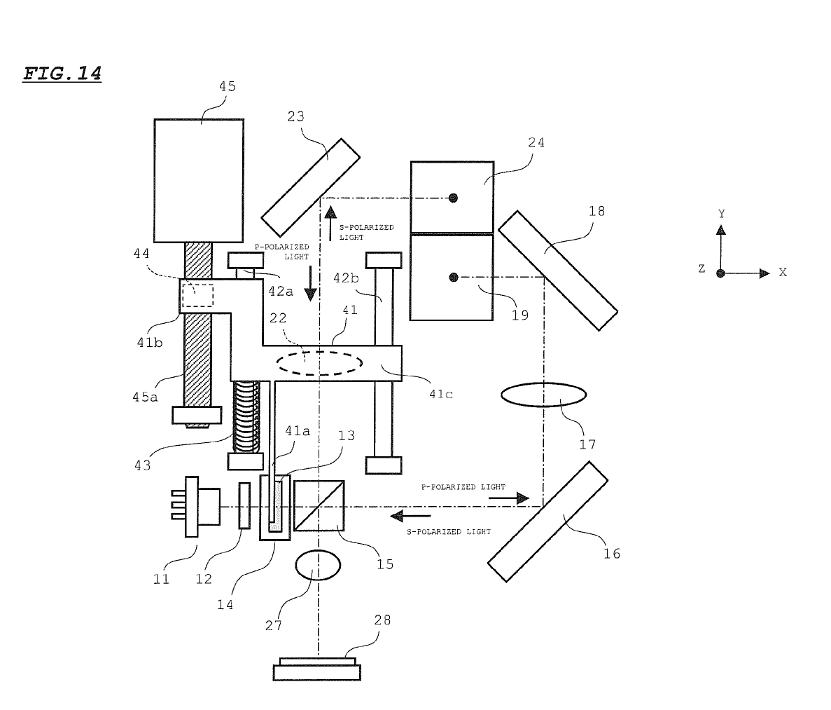

FIG. 14 shows a configuration example when only the collimator lens 17 is displaced. In this case, the lens holder 41 is moved to the first position (initial position of collimator lens 22) and the second position (non-operation position of collimator lens 22) by the servo circuit 53 of FIG. 4. Similarly the waveplate holder 13 is rotated and located at the first rotational position and the second rotational position in conjunction with the movement of the lens holder 41 to the first position and the second position. Therefore, the laser beam emitted from the semiconductor laser 11 is guided to one of the HD objective lens 21 and the BD objective lens 26.

The operation control during loading BD and HD is similar to that of FIG. 6. In this case, in S102 and S107, the lens holder 41 is moved to the first position (initial position of collimator lens 22) and the second position (non-operation position of collimator lens 22). However, in the configuration of FIG. 14, the servo operation (aberration servo) cannot be performed to the collimator lens 17. Therefore, in S110 of FIG. 6, the servo circuit 53 performs the servo operation (focus servo and tracking servo) only to the HD objective lens 21, and the servo circuit 53 does not perform the servo operation (aberration servo) to the collimator lens 17. In S105 of FIG. 6, the servo circuit 53 performs the servo operation (focus servo and tracking servo) to the BD objective lens 26 and the servo circuit 53 performs the servo operation (aberration servo) to the collimator lens 22.

In the embodiment, the present invention is applied to the optical pickup device compatible with BD and HD and the optical disk apparatus into which the optical pickup device is incorporated. The present invention can also be applied to other compatible optical pickup devices as appropriate. In the above description, the waveplate unit 13 is rotated in mechanical conjunction with the actuator displacing the collimator lens. Alternatively, the waveplate unit 13 may be rotated in mechanical conjunction with the actuator displacing other optical elements such as an expander lens or the like. In the embodiment, the polarization direction of the laser beam is adjusted using the half-wave plate 12. Alternatively, the polarization direction of the laser beam may be adjusted by rotating the semiconductor laser 11 about the optical axis.

Various changes and modifications of the embodiment can be made without departing from the scope of the technical idea though shown in claims of the present invention.

What is claimed is:

1. An optical pickup device comprising:
a laser source which emits a laser beam having a predetermined wavelength;
first and second objective lenses which cause the laser beam to converge onto a recording medium;
a polarization beam splitter which is disposed between the laser beam source and the first and second objective lenses;
first and second optical systems which guide the two laser beams split by the polarization beam splitter to the first and second objective lenses respectively;
first and second optical elements which are disposed in the first and second optical systems respectively;
an actuator which displaces the first and second optical elements in an optical axis direction of the laser beam;
a half-wave plate which is disposed between the laser beam source and the polarization beam splitter; and
a rotary mechanism which rotates the half-wave plate about an optical axis of the laser beam in mechanical conjunction with drive of the actuator,
wherein the rotary mechanism locates the half-wave plate at a first rotational position when the first optical element is located at a control operation position, and the rotary mechanism locates the half-wave plate at a second rotational position when the second optical element is located at the control operation position.

2. The optical pickup device according to claim 1, wherein a rotational position of the half-wave plate is switched between the first rotational position and the second rotational position to switch an optical system to which the laser beam travels between the first optical system and the second optical system.

3. The optical pickup device according to claim 1, wherein the first and second optical elements are lenses for correcting aberration generated in the laser beam.

4. The optical pickup device according to claim 1, wherein the actuator includes a transmission mechanism which adjusts drive strokes of the first optical element and the second optical element.

5. An optical pickup device comprising:
a laser source which emits a laser beam having a predetermined wavelength;
first and second objective lenses which cause the laser beam to converge onto a recording medium;
a polarization beam splitter which is disposed between the laser beam source and the first and second objective lenses;
first and second optical systems which guide the two laser beams split by the polarization beam splitter to the first and second objective lenses respectively;
an optical element which is disposed in one of the first and second optical systems;
an actuator which displaces the optical element in an optical axis direction of the laser beam;
a half-wave plate which is disposed between the laser beam source and the polarization beam splitter; and
a rotary mechanism which rotates the half-wave plate about an optical axis of the laser beam in mechanical conjunction with drive of the actuator,
wherein the rotary mechanism locates the half-wave plate at a first rotational position when the optical element is located at a control operation position, and the rotary mechanism locates the half-wave plate at a second rotational position when the optical element is located at a non-control operation position.

6. The optical pickup device according to claim 5, wherein a rotational position of the half-wave plate is switched between the first rotational position and the second rotational position to switch an optical system to which the laser beam travels between the first optical system and the second optical system.

7. The optical pickup device according to claim 5, wherein the first and second optical elements are lenses for correcting aberration generated in the laser beam.

8. An optical disk apparatus comprising:
an optical pickup device; and
a servo circuit which controls the optical pickup device,
wherein the optical pickup device includes:
a laser source which emits a laser beam having a predetermined wavelength;
first and second objective lenses which cause the laser beam to converge onto a recording medium;
a polarization beam splitter which is disposed between the laser beam source and the first and second objective lenses;
first and second optical systems which guide the two laser beams split by the polarization beam splitter to the first and second objective lenses respectively;
first and second optical elements which are disposed in the first and second optical systems respectively;
an actuator which displaces the first and second optical elements in an optical axis direction of the laser beam;
a half-wave plate which is disposed between the laser beam source and the polarization beam splitter; and
a rotary mechanism which rotates the half-wave plate about an optical axis of the laser beam in mechanical conjunction with drive of the actuator,
wherein the rotary mechanism locates the half-wave plate at a first rotational position when the first optical element is located at a control operation position, and the rotary mechanism locates the half-wave plate at a second rotational position when the second optical element is located at the control operation position,
wherein the servo circuit controlles the actuator to adjust optical characteristics of the laser beams incident to the first and second objective lenses, and drives the actuator to rotate the half-wave plate to guide the laser beam to one of the first and second optical systems.

9. An optical disk apparatus comprising:
an optical pickup device; and
a servo circuit which controls the optical pickup device,
wherein the optical pickup device includes:
a laser source which emits a laser beam having a predetermined wavelength;
first and second objective lenses which cause the laser beam to converge onto a recording medium;
a polarization beam splitter which is disposed between the laser beam source and the first and second objective lenses;
first and second optical systems which guide the two laser beams split by the polarization beam splitter to the first and second objective lenses respectively;
an optical element which is disposed in one of the first and second optical systems;
an actuator which displaces the optical element in an optical axis direction of the laser beam;
a half-wave plate which is disposed between the laser beam source and the polarization beam splitter; and
a rotary mechanism which rotates the half-wave plate about an optical axis of the laser beam in mechanical conjunction with drive of the actuator,
wherein the rotary mechanism locates the half-wave plate at a first rotational position when the optical element is located at a control operation position, and the rotary mechanism locates the half-wave plate at a second rotational position when the optical element is located at a non-control operation position,
wherein the servo circuit controlles the actuator to adjust optical characteristics of the laser beam incident to one of the first and second objective lenses, and drives the actuator to rotate the half-wave plate to guide the laser beam to one of the first and second optical systems.
